(19) United States
(12) Patent Application Publication
(10) Pub. No.: US 2008/0308352 A1
(43) Pub. Date: Dec. 18, 2008

(54) CONNECTION ARRANGEMENT FOR AN OIL PUMP OF A TRANSMISSION

(75) Inventors: Claus Form, Tettnang (DE); Waldemar Stark, Friedrichshafen (DE); Thomas Volk, Tettnang (DE); Stefan Serf, Kressbronn (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 12/125,310

(22) Filed: May 22, 2008

(30) Foreign Application Priority Data
Jun. 13, 2007 (DE) 10 2007 027 222.9

(51) Int. Cl. F16N 21/00

(52) U.S. Cl. 184/6

(57) ABSTRACT

A connection arrangement for a connection to an intake side of an oil pump in a housing (1) of a vehicle transmission is proposed, in which a separate intake connection element (4, 4′) with integrated intake booster is provided.

This application claims priority from German Application Serial No. 10 2007 027 222.9 filed Jun. 13, 2007.

### FIELD OF THE INVENTION

The present invention concerns a connection arrangement for an oil pump of a transmission.

### BACKGROUND OF THE INVENTION

From automotive technology connection arrangements for oil pumps for the supply of oil to clutches and brakes of a vehicle transmission located in a housing are known. For example, the document DE1 99 04 911 A1 discloses an automatic transmission in whose housing is arranged an oil pump designed to ensure, by way of a hydraulic control unit, a sufficient oil supply to the clutches and brakes of the automatic transmission.

An oil conduit, between the oil pump and the hydraulic control unit, is provided on a partition plate of the housing. The hydraulic control unit is attached on the underside of the partition plate. An intake pipe that coveys oil to the suction side of the oil pump engages in a corresponding opening of the partition plate and is then connected to an intake duct of the intake tract of the oil pump.

A further connection for a pump intake boost is provided on the intake tract of the oil pump. The intake boost is needed in order to avoid cavitation in the oil pump. Accordingly, via a corresponding boost flow line, oil under pressure is delivered from the pressure outlet to the intake tract. This boost flow line also passes through the partition plate of the housing.

The pump intake boost, provided for the intake tract of the oil pump, entails elaborate and cost-intensive component machining of the pressure die-casting. In addition, a corresponding design and machining of the partition plate is needed in order to enable the passages of the various oil ducts required. Furthermore, considerable space is taken up by the known connection arrangement.

Accordingly, the purpose of the present invention is to propose a connection arrangement of the type described in which both the intake duct and the boost duct can be accommodated in the housing of the vehicle transmission without complex component machining operations and with the least possible occupation of structural space.

### SUMMARY OF THE INVENTION

A connection arrangement for connection to an intake side of an oil pump in a transmission of a vehicle is proposed in which at least one separate intake connection element with integrated intake booster is provided.

This enables the boosting function to be integrated in the intake tract of the pump without the need for complex machining of the components. By using the proposed intake connection element, only one component is needed, which carries out both the intake function and the boosting function. Consequently components otherwise also needed can be omitted so the connection arrangement, according to the invention, has advantages in that the proposed connection arrangement can be used uniformly for at least one entire model series of transmissions.

In a particularly preferred embodiment of the invention, the intake connection element can be made as a plastic injection molding. This has the advantage that during the production of the intake connection element, the booster connection can be injection-molded into the plastic tube in the simplest manner, so that no further component machining is needed. However, other materials can also be used for the intake connection element.

In a further embodiment of the invention, the intake connection element has an approximate tubular, main body with an intake duct and with a booster duct. In this way, both the oil supply for the intake side of the pump and the oil duct for the booster on the intake side can be integrated in just one component.

Preferably, the main body that carries the intake duct can enable a straight connection of the intake side of the oil pump to an intake pipe. The intake pipe can convey oil to the intake side, for example from an oil sump. The use of the intake connection element in the connection arrangement enables length equalization between different structural levels by way of the intake pipe so that special designs of the oil sump are not necessary. This too results in a considerable cost advantage when the proposed connection arrangement is used.

The booster duct, provided in the main body, connects the intake side of the oil pump to the booster connection. In one possible embodiment of the invention, the booster connection can be arranged laterally on the main body. However other possible arrangements are also conceivable.

A lateral arrangement, however, has the advantage that the booster connection can be connected directly to a hydraulic control unit of the vehicle transmission, which controls the oil supply in the vehicle transmission. Lateral arrangement of the booster connection results in a curved path of the booster duct within the main body, which is optimum in terms of flow. Thus, with this arrangement, the intake connection element is integrated in the mechatronic unit, i.e., in the hydraulic control unit.

In a further embodiment of the invention, the end of the intake connection element on the pump side can be connected to a pump connection on the intake side on a housing partition plate of the vehicle transmission. In contrast, the end of the intake connection element remote from the pump can be connected to a connection flange of the intake pipe.

Although other connection options and components can also be used, the proposed arrangement has the advantage that no elaborate component-machining operations are needed so costs and assembly time can be saved.

### BRIEF DESCRIPTION OF THE DRAWINGS

The invention will now be described, by way of example, with reference to the accompanying drawings in which:

FIG. 1 is a sectional view of a possible embodiment of a connection arrangement according to the invention, in a housing of a vehicle transmission;

FIG. 2 is a sectional view of an embodiment of an intake connection element of the connection arrangement;

FIG. 3 is a sectional view of the intake connection element along the section line III-III in FIG. 2;

FIG. 4 is a sectional top view of the intake connection element along the section line IV-IV in FIG. 2;

FIG. 5 is a sectional view of a second embodiment of the intake connection element of the connection arrangement;

FIG. 6 is a sectional view of the intake connection element along the section line VI-VI in FIG. 5, and

FIG. 7 is a sectional top view of the intake connection element along the section line VII-VII in FIG. 5.

### DETAILED DESCRIPTION OF THE INVENTION

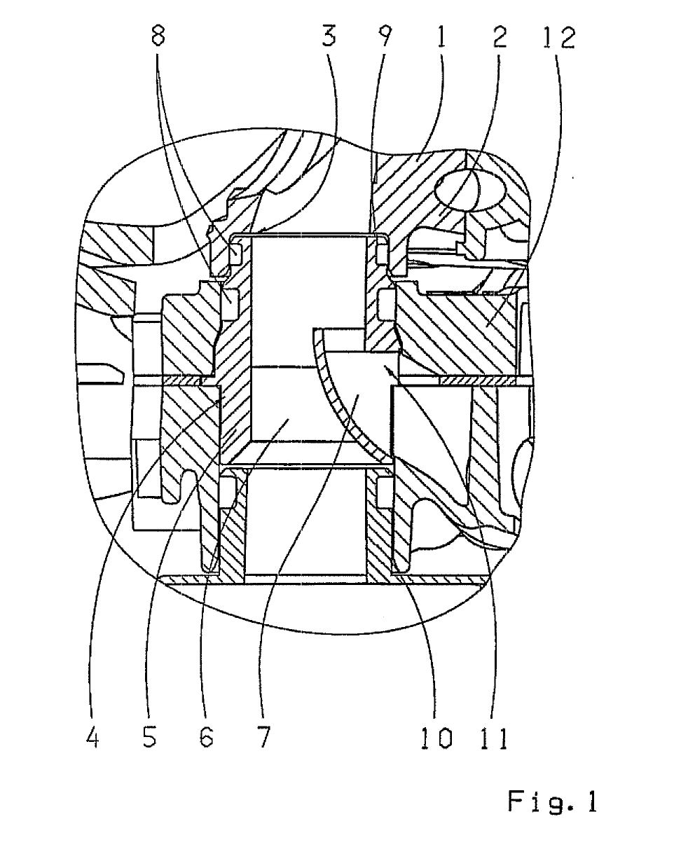

FIG. 1 shows a possible embodiment of a connection arrangement, according to the invention, for connection to an intake side of an oil pump arranged in a housing 1 of a vehicle transmission. The housing 1 comprises a partition plate 2 on which a connection 3 of the intake tract of the oil pump is provided.

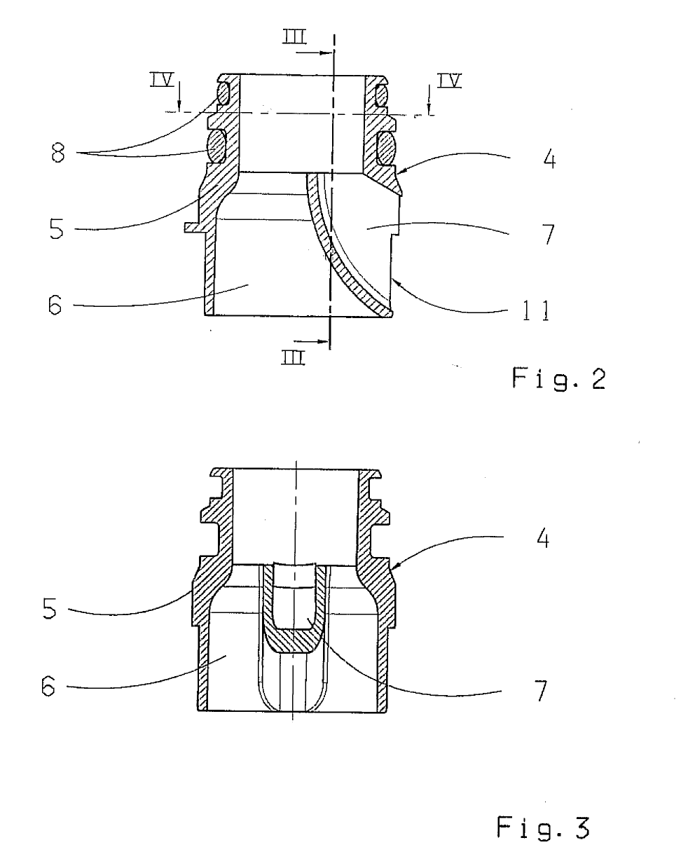

The connection arrangement comprises a separate intake connection element 4, 4′ which is connected to connection 3 of the intake tract of the oil pump. As can be clearly seen in the sectional views shown in FIGS. 2 to 7, the intake connection element 4, 4′ can be made as a separate component in either of the embodiments. This component is a plastic injection molding. In this way, the component can fulfill both the function of an intake and the function of boosting the intake flow.

The intake connection element 4, 4′ of the proposed connection arrangement comprises an approximately tubular main body 5 with an intake duct 6 and a booster duct 7, which are spatially separate from one another. The intake duct 6 serves to convey oil from an oil sump (not shown) to the intake side of the oil pump. The booster duct 7 serves to deliver to the intake side of the oil pump oil, pressurized to the system pressure in order to boost the intake oil flow so as to prevent cavitation in the oil pump.

The end of the intake connection element 4.4′ facing toward the oil pump, is connected such that a connection 9 sealed with seal elements 8 to the intake-side connection 3 of the partition plate 2 of the housing 1. The end of the intake connection element 4, 4′, remote from the oil pump, is connected via a connection flange 10 to an intake pipe (not shown).

A booster connection 11, integrated in the main body 5, is provided laterally on the intake connection element 4 and, in the embodiment shown in FIG. 1, is connected directly to a hydraulic control unit 12.

The hydraulic control unit 12 serves to control the oil supply flow for the clutches and brakes provided in the vehicle transmission. Since the intake connection element 4, 4′ with the integrated booster connection 11 is made as a single component which fulfills the functions of both intake and boosting the intake flow, no other components or component-machining operations are needed. Particularly advantageously, the intake connection element 4, 4′ is integrated in the mechatronic or hydraulic control unit 12 in the area of the intake tract of the oil pump.

FIGS. 2 to 4 show a first embodiment of the intake connection element 4, which can preferably be used with an eight-gear automatic transmission. FIG. 2 shows a longitudinal section. From this view, it can be seen that the main body 5 comprises the approximately straight, intake duct 6 and the booster duct 7 separate or distinct from it.

The booster duct 7 is of curved shape and ends at the booster connection 11 arranged laterally on the main body 5. To seal the joint between the connection 9 of the intake connection element 4 and the connection 3 on the pump side, seal elements 8 are provided in the form of rings.

FIG. 3 shows another longitudinally sectioned view along the section line III-III in FIG. 2. In particular, this view shows the approximately rectangular, cross-section shape of the booster duct 7.

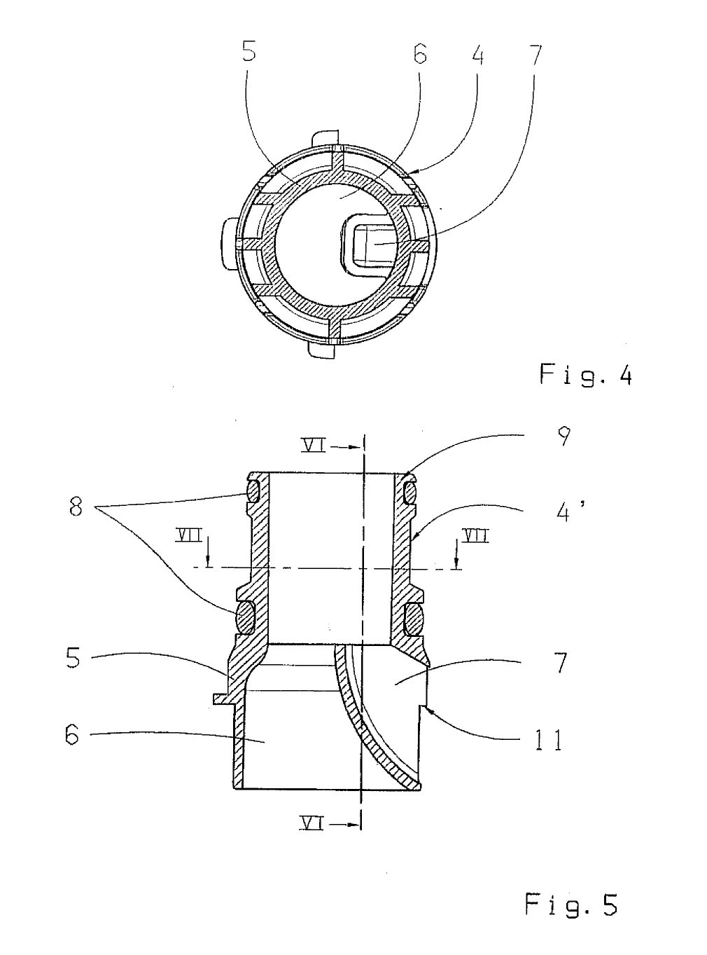

In contrast, FIG. 4 shows a top view of the intake connection element 4, sectioned along the line IV-IV in FIG. 2. From this view, in particular it can be seen that the booster duct 7 is located approximately centrally in the intake duct 6, whose cross-section is approximately circular.

FIGS. 5 to 7 show a second embodiment of the intake connection element 4′, the same components being given the same index numbers. This intake connection element 4′ is preferably used with an eight-gear automatic transmission for all-wheel-drive vehicles.

FIG. 5 shows a longitudinally sectioned view of this second embodiment of the intake connection element 4′ from which it can be seen that the connection 9′ on the pump side is somewhat longer compared with that in the first embodiment.

In this second embodiment too, seals 8 in the form of rings are provided in order to seal the joint between the connection 9 of the intake connection element 4 and the connection 3 on the pump side.

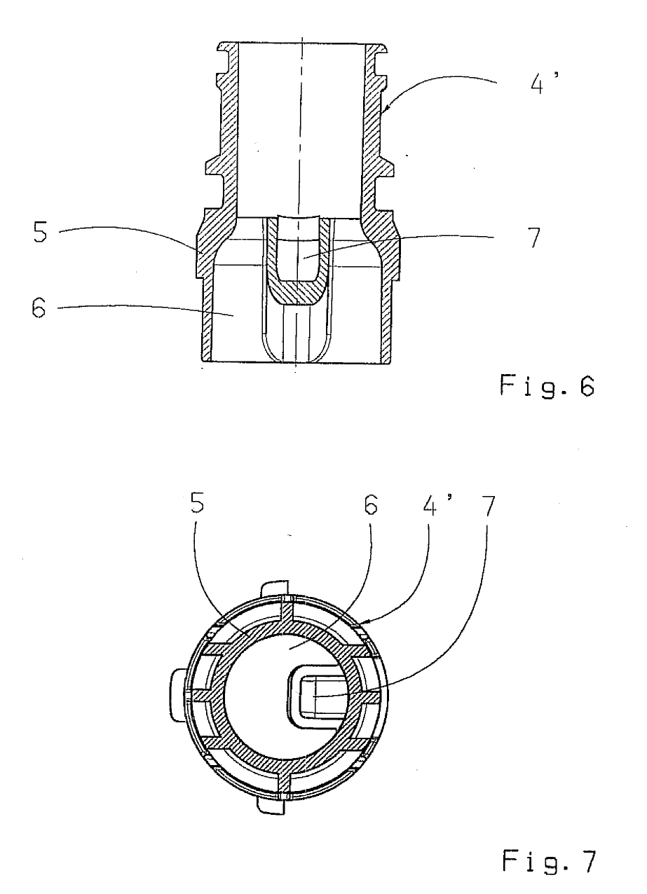

FIG. 6 shows a longitudinal section of the intake connection element 4′ taken along the line VI-VI in FIG. 5. FIG. 7 shows a sectioned top view of the second embodiment of the connection element 4′, along the line VII-VII in FIG. 5. The shape of the connection element 4′ and the design of the intake duct 6 and the booster duct 7 are identical to those in the first embodiment. The difference from the first embodiment is that the connection 9 of the intake connection element 4′ is longer in order to adapt to the range of application in a transmission of an all-wheel-drive vehicle.

### REFERENCE NUMERALS

1 housing
2 partition plate
3 connection of the intake tract
4, 4′ intake connection element
5 main body
6 intake duct
7 booster duct
8 seals
9 connection of the intake connection element
10 connection flange
11 booster connection
12 hydraulic control unit

1-9. (canceled)

10. A connection arrangement for connection to an intake side of an oil pump arranged in a housing (1) of a vehicle transmission, wherein a separate intake connection element (4, 4′) is provided with an integrated intake boost.

11. The connection arrangement according to claim 10, wherein the connection element (4, 4′) is a plastic injection molding.

12. The connection arrangement according to claim 10, wherein the intake connection element (4, 4′) has a tubular main body (5) with an intake duct (6) and a boost duct (7).

13. The connection arrangement according to claim 12, wherein the intake duct (6) connects the intake side of the oil pump with an intake pipe.

14. The connection arrangement according to claim 12, wherein the boost duct (7) connects the intake side of the oil pump with a boost connection (11) of the connection element (4, 4′).

15. The connection arrangement according to claim 14, wherein the boost connection (11) is arranged laterally on the tubular main body (5).

16. The connection arrangement according to claim 14, wherein the boost connection (11) is connected directly to a hydraulic control unit (12) of the vehicle transmission.

17. The connection arrangement according to claim 10, wherein a connection (9) on a pump side of the intake connection element (4, 4′) is connected to a connection (3) of the oil pump on the intake side, which is on a partition plate (2) of a housing (1) of the vehicle transmission.

18. The connection arrangement according to claim 10, wherein an end of the intake connection element (4, 4′), facing away from the oil pump, is connected to a connection flange (10) of an intake pipe.

19. An oil intake connection element (4, 4′) coupled to an oil pump, the connection element (4, 4′) comprising:
a generally cylindrical tubular main body (5) having an outlet end through which oil flows from an interior of the main body (5) of the connection element (4, 4′) to an oil pump;
an intake duct (6) extends from an inlet end of the main body (5) opposite the outlet end to the interior of the main body (5), and the oil flowing through the intake duct (6) into the interior of the main body (5) of the connection element (4, 4′); and
a booster duct (7) extends from a side of the main body (5) toward the interior of the main body (5), pressurized oil flows through the booster duct (7) into the interior of the main body (5), and the booster duct (7) is arcuate such that the flow of the pressurized oil is directed from the interior of the main body (5) to the outlet end of the main body (5).
